(19) United States
(12) Patent Application Publication
(10) Pub. No.: US 2003/0047723 A1
(43) Pub. Date: Mar. 13, 2003

(54) Dry powdered fire retardant composition for mixing with water on-site for elimination of corrosion inhibitors required if pre-mixed and stored

(76) Inventor: Dario Santoro, Port Jefferson, NY (US)

Correspondence Address: Dario Santoro, 17 Laurita Gate, Port Jefferson, NY, 11777, US

(21) Appl. No.: 09/947,167

(22) Filed: Sep. 5, 2001

(51) Int. Cl. C09K 21/00

(52) U.S. Cl. 252/601; 252/603; 252/607

(57) ABSTRACT

A dry powdered fire retardant composition for mixing with water on-site for elimination of corrosion inhibitors required if pre-mixed and stored. The composition includes a gum and a fire retardant salt. The gum is a dry powdered guava fruit gum which is extremely hydroscopic for mixing on-site. The fire retardant salt is a dry powdered mono-ammonium phosphate. The composition further includes dry powdered 1-3% bicarbonate of soda for adding additional insulating properties. The method of making the dry powdered fire retardant composition includes the steps of putting the dry powdered guava fruit gum in a mixer, putting the dry powdered mono-ammonium phosphate in the mixer, and mixing the dry powdered guava fruit gum and the dry powdered mono-ammonium phosphate evenly in the mixer.

### BACKGROUND OF THE INVENTION

1. Field of the Invention

The present invention relates to a dry powdered fire retardant composition. More particularly, the present invention relates to a dry powdered fire retardant composition for mixing with water on-site for elimination of corrosion inhibitors required if pre-mixed and stored.

2. Description of the Prior Art

Ignition of a flammable structure or other materials, such as trees downwind from a forest fire, brush fire, or another burning building is generally caused by wind-carried burning embers which fall on roofs or which strike a wall and fall to the ground next to the structure or otherwise make contact with it.

The main method of protecting a threatened building is to hose the roof of the building with water to wet any portion which may be exposed to ignition. Often, however, the water supply or pressure is inadequate or the temperature is so high and humidity so low that rapid drying occurs. Also, many flammable surfaces are relatively nonabsorbent so that they retain little water.

Forest fires and brush fires annually cause the loss of millions of dollars worth of timber and other property. Huge damage occurs because usually by the time the fire is detected and before control measures can be applied, it is out of control in a condition known as “wildfire.” Not only is the direct property loss due to such fired catastrophic, but associated soil erosion and watershed problems are also significant. It is important, therefore, to minimize and control the spread of forest fires whenever possible.

A wide variety of fire retardant compositions which are used to prevent or combat the spread of wildfires (forest fires, range fires, etc.) have been proposed.

Generally, such compositions contain a fire retardant salt (e.g. ammonium phosphate-monobasic ammonium phosphate (MAP) and/or dibasic ammonium phosphate (DAP)-, ammonium polyphosphate, ammonium sulfate, and the like, an aqueous liquid vehicle, and various functional additives which improve specific characteristics of the composition. These functional additives may include, e.g. thickeners to improve the ariel drop and fuel coverage characteristics, corrosion inhibitors to reduce the corrosivity of the compositions to metal components of storage and application equipment, coloring agents to improve the accuracy and coverage of successive aerial applications, stabilizing agents to prevent separation of the various components of the composition during storage and transport, and spoilage inhibitors to prevent microbial decomposition of certain components, etc.

Substantial amounts of fire retardants are stored in the “ready-to-use” mixed state at tanker aircraft bases. Because of uncertainties of weather and other conditions, an aerial tanker base will typically reach the end of a fire season with very substantial amounts of mixed retardants on hand. This product must be stored and held over for use during the following year. Therefore, the product must retain a substantial amount of its original viscosity until the next fire season.

Also, because of the necessity to store substantial quantities of the mixed fire-retardant products at these air tanker bases, it is necessary to inhibit the corrosivity of mixed products to the mild steel from which the storage tanks are typically fabricated.

The principal user of such fire-retardant compositions in the Unite States is the U.S. Forest Service of the United States Department of Agriculture. To insure the long-term stability and corrosion characteristics of the fire-retardant compositions which it purchases and applies, the Forest Service imposes tight restrictions on these characteristics. These specifications have been published as “Specification 5100-304a” (February 1986), incorporated herein by reference thereto. These current specifications are considerably more stringent than similar specifications previously in effect. In particular, the specification for these products as to corrosion of mild steel has been set at a maximum of 5.0 mils per year as determined by the procedures set forth in the specification.

Moreover, the new 304a specification of Feb., 1986 requires that the long-term (one year) stability of mixed retardants be such that the mixed retardant exhibits less than 10% visual separation in one year and that the mixed retardant retain at least 60% of its original steady state viscosity during this period.

These requirements of corrosivity inhibition and mixed product stability are contradictory, because many of the corrosion inhibitors which are known to reduce the corrosivity of such compositions, also act to reduce the stability of the mixed compositions.

It would therefore be highly desirable to provide a fire retardant composition not requiring a corrosion inhibitor.

Numerous innovations for fire retardant compositions have been provided in the prior art that will be described. Even though these innovations may be suitable for the specific individual purposes to which they address, however, they differ from the present invention in that they do not teach a dry powdered fire retardant composition for mixing with water on-site for elimination of corrosion inhibitors required if pre-mixed and stored.

FOR EXAMPLE, U.S. Pat. No. 4,101,485 to Brooks et al. teaches a concentrated ammonium salt composition containing a binder and viscosity control agent usable in aqueous dispersion. The dispersion is applied to foliage and vegetation to hinder or prevent wildfires for one complete season.

ANOTHER EXAMPLE, U.S. Pat. No. 4,384,988 to Schoenholz et al. teaches a water barrier gel composition comprising from about 0.1 to 5% by weight of water absorbent material and from about 95 to 99.9% by weight of water, based on the weight of the total composition, and a method of applying a layer of said water-barrier gel composition to a surface to prevent ignition or to protect the surface from heat damage.

STILL ANOTHER EXAMPLE, U.S. Pat. No. 4,822,524 to Strickland teaches a fire-retardant composition for application to vegetation, to suppress the spread of wildfires of the type which includes a fire-suppressing salt in a liquid carrier, has a minor amount of xanthan gum incorporated therein to improve the stability, corrosivity or adhesion of the composition.

YET ANOTHER EXAMPLE, U.S. Pat. No. 5,958,117 to Crouch et al. teaches a gum-thickened fire retardant composition with improved stability and/or corrosion resistance that contains a fire retardant salt, a gum thickener, an aqueous liquid carrier, and at least one non-toxic water-soluble additive, which is at least one carboxylic acid or salt thereof, having the structural formula ##STR1## wherein R is a substituted or unsubstituted phenyl group, or a substituted or unsubstituted carbon chain containing conjugated unsaturation, and X is hydrogen or a metal. The additive component is present in an amount effective to improve the stability of the composition and/or reduce the corrosivity of the composition to iron. Preferred compositions containing the combination of at least one compound in which R is a phenyl group, especially sodium benzoate, and at least one compound in which R is a carbon chain containing unconjugated unsaturation, especially sorbic acid.

It is apparent that numerous innovations for fire retardant compositions have been provided in the prior art that are adapted to be used. Furthermore, even though these innovations may be suitable for the specific individual purposes to which they address, however, they would not be suitable for the purposes of the present invention as heretofore described, since they fo not teach a dry powdered fire retardant composition for mixing with water on-site for elimination of corrosion inhibitors required if pre-mixed and stored.

### SUMMARY OF THE INVENTION

ACCORDINGLY, AN OBJECT of the present invention is to provide a dry powdered fire retardant composition for mixing with water on-site for elimination of corrosion inhibitors required if pre-mixed and stored that avoids the disadvantages of the prior art.

ANOTHER OBJECT of the present invention is to provide a dry powdered fire retardant composition for mixing with water on-site for elimination of corrosion inhibitors required if pre-mixed and stored that is simple and inexpensive to manufacture.

STILL ANOTHER OBJECT of the present invention is to provide a dry powdered fire retardant composition for mixing with water on-site for elimination of corrosion inhibitors required if pre-mixed and stored that is simple to use.

BRIEFLY STATED, YET ANOTHER OBJECT of the present invention is to provide a dry powdered fire retardant composition for mixing with water on-site for elimination of corrosion inhibitors required if pre-mixed and stored. The composition includes a gum and a fire retardant salt. The gum is a dry powdered guava fruit gum which is extremely hydroscopic for mixing on-site. The fire retardant salt is a dry powdered mono-ammonium phosphate. The composition further includes a dry powdered 1-3% bicarbonate of soda for adding additional insulating properties, by virtue of producing CO₂ which expands the composition requiring less thereof. The method of making the dry powdered fire retardant composition includes the steps of putting the dry powdered guava fruit gum in a mixer, putting the dry powdered mono-ammonium phosphate in the mixer, and mixing the dry powdered guava fruit gum and the dry powdered mono-ammonium phosphate evenly in the mixer so as to form the dry powdered fire retardant composition. The method of using the dry powdered fire retardant composition includes the steps of attaching a supply of water to a water inlet of a disperser of an aspirator, attaching a funnel or a suitable hopper to a feed inlet of the dispenser of the aspirator, aiming a discharge outlet of the disperser of the aspirator, turning on the water supply, and feeding the dry powdered fire retardant composition gradually into the funnel or the suitable hopper of the aspirator, which is drawn through a uniform bore in the disperser of the aspirator, by virtue of gravity and vacuum created by constriction in water flow through an annular orifice in the disperser of the aspirator, causing each particle of the dry powdered fire retardant composition to be individually wetted and mixed with the water upon discharge from the discharge outlet of the aspirator.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIG. 1 is a diagrammatic elevational view of an aspirator for use in the method of using the present invention;

FIG. 2 is a process flow chart for making the present invention; and

FIGS. 3A-3B are a process flow chart for using the present invention.

### LIST OF REFERENCE NUMERALS UTILIZED IN THE DRAWING

| | |
|---|---|
| 10 | typical aspirator |
| 12 | disperser |
| 14 | funnel |
| 16 | feed inlet of disperser 12 |
| 18 | discharge outlet of disperser 12 |
| 20 | water inlet of disperser 12 for |
| | fluidly communicating with supply of water |
| 22 | wide mouth of funnel 14 |
| 24 | narrow outlet of funnel 14 |

### DETAILED DESCRIPTION OF THE PREFERRED EMBODIMENT

The dry powdered fire retardant composition for mixing with water on-site for elimination of corrosion inhibitors required if pre-mixed and stored of the present invention comprises:

1. A gum.

2. A fire retardant salt.

The gum is a fruit gum.

The fruit gum is guava fruit gum made from a guava fruit, which is less expensive than other fruit gums and is extremely hydroscopic for mixing on-site and reducing storage requirements and the corrosion inhibitors required if pre-mixed and stored.

A typical guava fruit gum is sold by TIC GUMS of 4609 Richlynn Drive, P.O. Box 369, Belcamp, Md. 21017 USA, (410) 273-7300, (800) 221-3953, Fax: (410) 273-6469, http://www.ticgums.com. info@ticgums.com.

The guava fruit gum is a dry powder.

The fire retardant salt is mono-ammonium phosphate.

The mono-ammonium phosphate is a dry powder.

The dry powdered fire retardant composition for mixing with water on-site for elimination of corrosion inhibitors required if pre-mixed and stored further comprises an expanding agent for adding additional insulating properties.

The expanding agent is bicarbonate of soda which adds the additional insulating properties by virtue of producing CO₂ which expands the composition requiring less thereof.

The bicarbonate of soda is 1-3% bicarbonate of soda.

The bicarbonate of soda is a dry powder.

The method of making the dry powdered fire retardant composition for mixing with water on-site for elimination of corrosion inhibitors required if pre-mixed and stored comprises the steps of:

STEP 1: Putting the gum in a mixer.

STEP 2: Putting the fire retardant salt in the mixer.

STEP 3: Mixing the gum and the fire retardant salt evenly in the mixer so as to form the dry powdered fire retardant composition.

When the dry powdered fire retardant composition is added to water, there is a marked tendency to clump or form “fish eyes.” In the past, it would have been necessary to premix the dry powdered fire retardant composition with dispersing agents, such as sugar or glycol to prevent lumping.

Using an aspirator, however, the dry powdered fire retardant composition can be dispersed in water instantly and continuously without lumping. Hydration takes place immediately as the dry powdered fire retardant composition is sucked into the water stream while in the disperser of the aspirator.

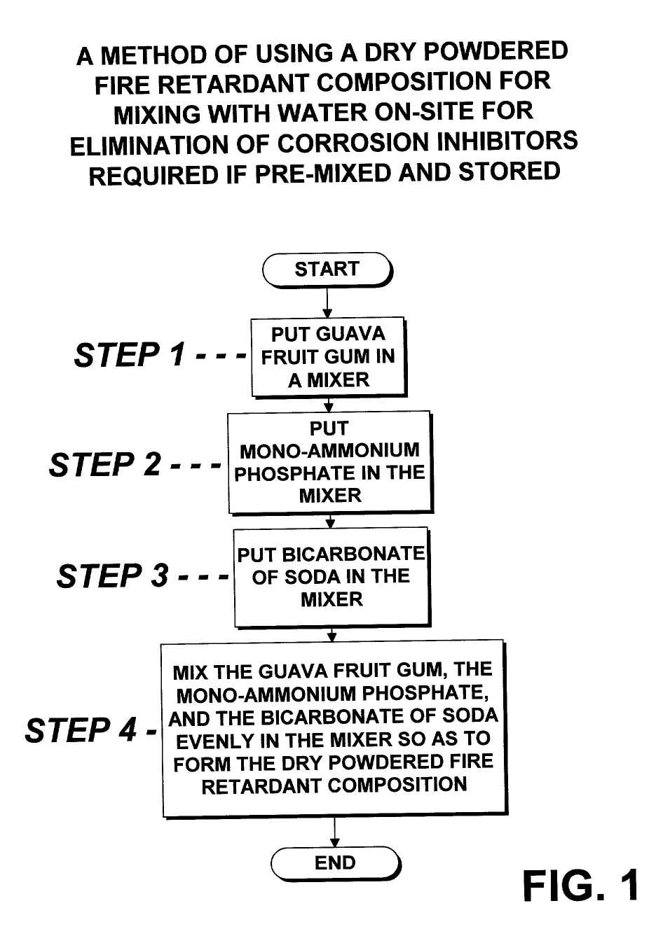

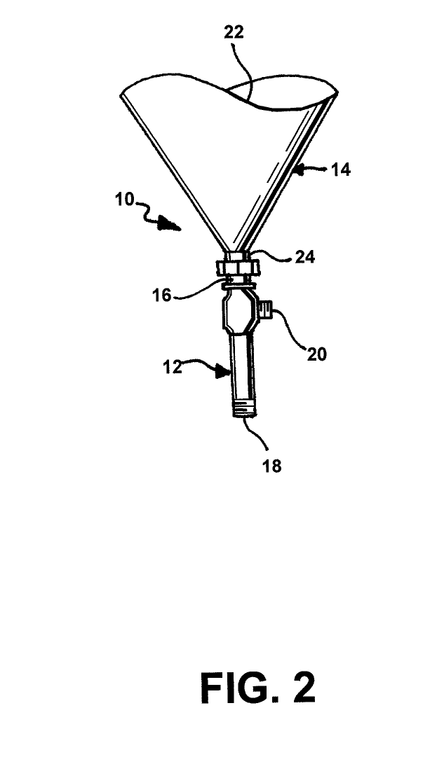

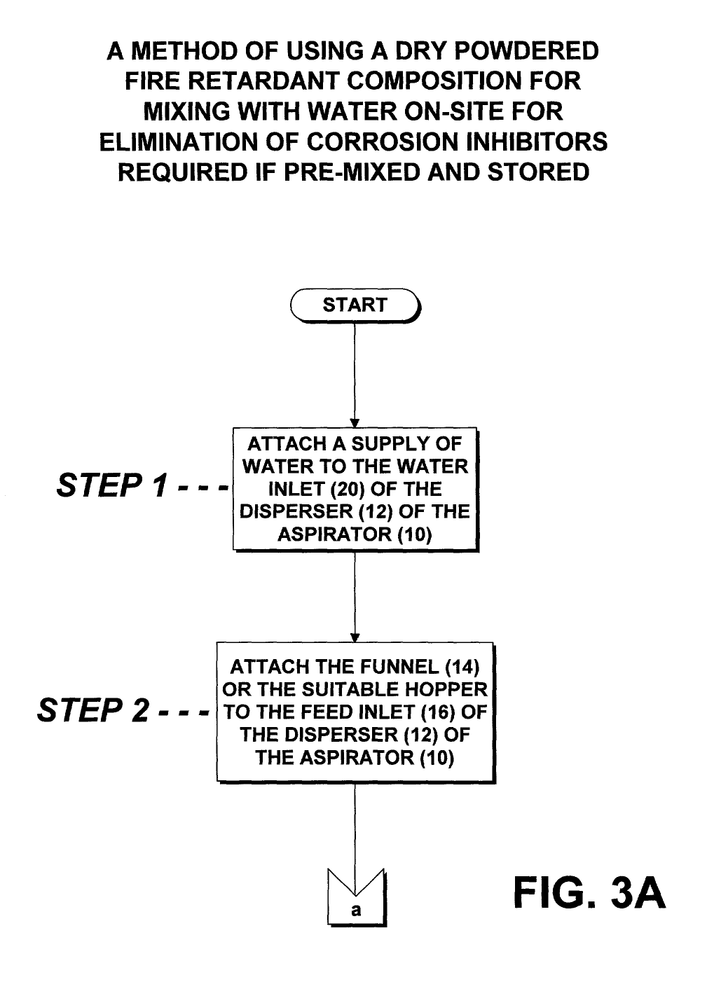

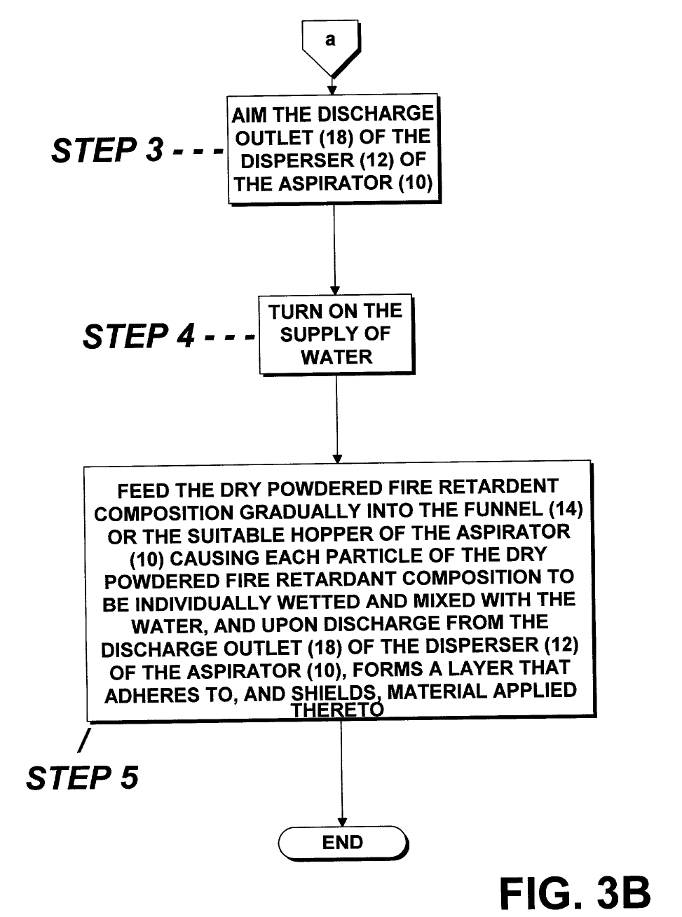

The configuration of a typical aspirator 10 can best be seen in FIG. 1, which is an exploded diagrammatic elevational view of an aspirator for use in the method of using the present invention, and as such, will be discussed with reference thereto.

A typical aspirator 10 is sold under the tradename ANDON by TIC GUMS of 4609 Richlynn Drive, P.O. Box 369, Belcamp, Md. 21017 USA, (410) 273-7300, (800) 221-3953, Fax: (410) 273-6469, http://www.ticgums.com. info@ticgums.com.

The typical aspirator 10 comprises a disperser 12 and a funnel 14 operatively connected to the disperser 12.

The disperser 12 is hollow, slender, elongated, vertically-oriented, and has a feed inlet 16 communicatingly attached to the funnel 14 and a discharge outlet 18 disposed opposite the feed inlet 16.

The disperser 12 further has a water inlet 20 for fluidly communicating with a supply of water. The water inlet 20 is horizontally-oriented and disposed communicatingly between, and perpendicular to, the feed inlet 16 thereof and the discharge outlet 18 thereof, but closer to the feed inlet 16 thereof.

The funnel 14 is vertically-oriented, and by definition, has a wide mouth 22 and a narrow outlet 24 that threadably attaches onto, and communicates with, the feed inlet 16 of the disperser 12.

As an example, the model 62DP disperser 12 will be discussed infra. It is to be understood, however, that the selection of the model 62DP disperser 12 is for illustrative purposes only, and that the selection of an appropriate disperser 12 will depend upon the volume of the dry powdered fire retardant composition needed, which will be dictated by the size of the fire.

The model 62DP disperser 12 can effectively wet five pounds of the dry powdered fire retardant composition for each ten to fifteen gallons of water supplied, resulting in a 4 to 6% concentration of the dry powdered fire retardant composition in the water.

Water supply pressures from 20-100 psi can be used with the model 62DP disperser 12. While the model 62DP disperser 12 requires just a minimum pressure 20 psi (100 kg/m²), best results are obtained when the water pressure is 50-55 psi (250-275 kg/m²).

The values in TABLE 1 infra show the flow rate of water in GPM at various supply pressures with standard orifice settings and ¾″ pipe size of the model 62DP disperser 12,

TABLE 1

| WATER SUPPLY PRESSURE | |
|---|---|
| AT WATER INLET 20 IN PSI | WATER FLOW RATE IN GPM |
| 20 | 8 |
| 40 | 12 |
| 60 | 15 |
| 80 | 17 |
| 100 | 20 |

The method of using the dry powdered fire retardant composition for mixing with water on-site for elimination of corrosion inhibitors required if pre-mixed and stored comprises the steps of:

STEP 1: Attaching a supply of water to the water inlet 20 of the disperser 12 of the aspirator 10.

STEP 2: Attaching the funnel 14 or a suitable hopper to the feed inlet 16 of the disperser 12 of the aspirator 10.

STEP 3: Aiming the discharge outlet 18 of the disperser 12 of the aspirator 10.

STEP 4: Turning on the supply of water.

STEP 5: Feeding the dry powdered fire retardant composition gradually into the funnel 14 or the suitable hopper of the aspirator, which is drawn through a uniform bore in the disperser 12 of the aspirator 10, by virtue of gravity and vacuum created by constriction in flow of the water through an annular orifice in the disperser 12 of the aspirator 10, causing each particle of the dry powdered fire retardant composition to be individually wetted and mixed with the water, and upon discharge from the discharge outlet 18 of the disperser 12 of the aspirator 10, forms a layer that has minimal evaporation of the water, adheres to, and shields, material applied to from high temperatures of fire until 212 degrees which is the boiling point of the water, and is biodegradable after a period subsequent to application.

It will be understood that each of the elements described above, or two or more together, may also find a useful application in other types of constructions differing from the types described above.

While the invention has been illustrated and described as embodied in a dry powdered fire retardant composition for mixing with water on-site for elimination of corrosion inhibitors required if pre-mixed and stored, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A dry powdered fire retardant composition for mixing with water on-site for elimination of corrosion inhibitors required if pre-mixed and stored, comprising:
a) a gum; and
b) a fire retardant salt.

2. The composition as defined in claim 1, wherein said gum is a fruit gum.

3. The composition as defined in claim 2, wherein said fruit gum is a guava fruit gum made from a guava fruit which is less expensive than other fruit gums and is extremely hydroscopic for mixing on-site and reducing storage requirements and the corrosion inhibitors required if pre-mixed and stored.

4. The composition as defined in claim 3, wherein said guava fruit gum is a dry powder.

5. The composition as defined in claim 1, wherein said fire retardant salt is mono-ammonium phosphate.

6. The composition as defined in claim 5, wherein said mono-ammonium phosphate is a dry powder.

7. The composition as defined in claim 1; further comprising an expanding agent for adding additional insulating properties.

8. The composition as defined in claim 7, wherein said expanding agent is bicarbonate of soda which adds the additional insulating properties by virtue of producing CO₂ which expands said composition requiring less thereof.

9. The composition as defined in claim 8, wherein said bicarbonate of soda is 1-3% bicarbonate of soda.

10. The composition as defined in claim 8, wherein said bicarbonate of soda is a dry powder.

11. A method of making a dry powdered fire retardant composition for mixing with water on-site for elimination of corrosion inhibitors required if pre-mixed and stored, comprising the steps of:
a) putting a gum in a mixer;
b) putting a fire retardant salt in the mixer; and
c) mixing the gum and the fire retardant salt evenly in the mixer so as to form the dry powdered fire retardant composition.

12. The method as defined in claim 11, wherein said step of putting a gum in a mixer includes putting a fruit gum in a mixer.

13. The method as defined in claim 12, wherein said step of putting a fruit gum in a mixer includes putting a guava fruit gum made from a guava fruit which is less expensive than other fruit gums and is extremely hydroscopic for mixing on-site and reducing storage requirements and the corrosion inhibitors required if pre-mixed and stored in a mixer.

14. The method as defined in claim 13, wherein said step of putting a guava fruit gum made from a guava fruit which is less expensive than other fruit gums and is extremely hydroscopic for mixing on-site and reducing storage requirements and the corrosion inhibitors required if pre-mixed and stored in a mixer includes putting a dry powdered guava fruit gum made from a guava fruit which is less expensive than other fruit gums and is extremely hydroscopic for mixing on-site and reducing storage requirements and the corrosion inhibitors required if pre-mixed and stored in a mixer.

15. The method as defined in claim 111, wherein step of putting a fire retardant salt in the mixer includes putting mono-ammonium phosphate in the mixer.

16. The method as defined in claim 12, wherein step of putting mono-ammonium phosphate in the mixer includes putting a dry powdered mono-ammonium phosphate in the mixer.

17. The method as defined in claim 11; further comprising the steps of:
a) putting an expanding agent in the mixer for adding additional insulating properties; and
b) mixing the gum, the fire retardant salt, and the bicarbonate of soda evenly in the mixer so as to form the dry powdered fire retardant composition.

18. The method as defined in claim 17, wherein said step of putting an expanding agent in the mixer for adding additional insulating properties includes putting bicarbonate of soda in the mixer for adding additional insulating properties, by virtue of producing CO₂ which expands the composition requiring less thereof.

19. The method as defined in claim 17, wherein said step of putting bicarbonate of soda in the mixer for adding additional insulating properties, by virtue of producing CO₂ which expands the composition requiring less thereof; includes putting 1-3% bicarbonate of soda in the mixer for adding additional insulating properties, by virtue of producing CO₂ which expands the composition requiring less thereof.

20. The method as defined in claim 17, wherein said step of putting bicarbonate of soda in the mixer for adding additional insulating properties, by virtue of producing CO₂ which expands the composition requiring less thereof; includes putting dry powdered bicarbonate of soda in the mixer for adding additional insulating properties, by virtue of producing CO₂ which expands the composition requiring less.

21. A method of using a dry powdered fire retardant composition for mixing with water on-site for elimination of corrosion inhibitors required if pre-mixed and stored, comprising the steps of:
a) attaching a supply of water to a water inlet of a disperser of an aspirator;
b) attaching a funnel or a suitable hopper to a feed inlet of the dispenser of the aspirator;
c) aiming a discharge outlet of the disperser of the aspirator;
d) turning on the supply of water; and
e) feeding the dry powdered fire retardant composition gradually into the funnel or the suitable hopper of the aspirator, which is drawn through a uniform bore in the disperser of the aspirator, by virtue of gravity and vacuum created by constriction in flow of the water through an annular orifice in the disperser of the aspirator, causing each particle of the dry powdered fire retardant composition to be individually wetted and mixed with the water, and upon discharge from the discharge outlet of the aspirator, forms a layer that has minimal evaporation of the water, adheres to, and shields, material applied to from high temperatures of fire until 212 degrees which is the boiling point of the water, and is biodegradable after a period subsequent to application.

22. The method as defined in claim 21, wherein said step of feeding the dry powdered composition gradually into the funnel or the suitable hopper of the aspirator includes feeding a gum and a fire retardant salt gradually into the funnel or the suitable hopper of the aspirator.

23. The method as defined in claim 22, wherein said step of feeding a gum and a fire retardant salt gradually into the funnel or the suitable hopper of the aspirator includes feeding a fruit gum and a fire retardant salt gradually into the funnel or the suitable hopper of the aspirator.

24. The method as defined in claim 23, wherein said step of feeding a fruit gum and a fire retardant salt gradually into the funnel or the suitable hopper of the aspirator includes feeding a guava fruit gum made from a guava fruit which is less expensive than other fruit gums and is extremely hydroscopic for mixing on-site and reducing storage requirements and the corrosion inhibitors required if pre-mixed and stored and a fire retardant salt gradually into the funnel or the suitable hopper of the aspirator.

25. The method as defined in claim 24, wherein said step of feeding a guava fruit gum made from a guava fruit which is less expensive than other fruit gums and is extremely hydroscopic for mixing on-site and reducing storage requirements and the corrosion inhibitors required if pre-mixed and stored and a fire retardant salt gradually into the funnel or the suitable hopper of the aspirator includes feeding a dry powdered guava fruit gum made from a guava fruit which is less expensive than other fruit gums and is extremely hydroscopic for mixing on-site and reducing storage requirements and the corrosion inhibitors required if pre-mixed and stored and a fire retardant salt gradually into the funnel or the suitable hopper of the aspirator.

26. The method as defined in claim 21, wherein said step of feeding a gum and a fire retardant salt gradually into the funnel or the suitable hopper of the aspirator includes feeding a gum and mono-ammonium phosphate gradually into the funnel or the suitable hopper of the aspirator.

27. The method as defined in claim 26, wherein said step of feeding a gum and mono-ammonium phosphate gradually into the funnel or the suitable hopper of the aspirator includes feeding a gum and dry powdered mono-ammonium phosphate gradually into the funnel or the suitable hopper of the aspirator.

28. The method as defined in claim 21, wherein said step of feeding a gum and a fire retardant salt gradually into the funnel or the suitable hopper of the aspirator includes feeding a gum, a fire retardant salt, and an expanding agent for adding additional insulating properties gradually into the funnel or the suitable hopper of the aspirator.

29. The method as defined in claim 28, wherein said step of feeding a gum, a fire retardant salt, and an expanding agent for adding additional insulating properties gradually into the funnel or the suitable hopper of the aspirator includes feeding a gum, a fire retardant salt, and bicarbonate of soda which adds the additional insulating properties by virtue of producing CO₂ which expands the composition requiring less thereof gradually into the funnel or the suitable hopper of the aspirator.

30. The method as defined in claim 29, wherein said step of feeding a gum, a fire retardant salt, and bicarbonate of soda which adds the additional insulating properties by virtue of producing CO₂ which expands the composition requiring less thereof gradually into the funnel or the suitable hopper of the aspirator includes feeding a gum, a fire retardant salt, and 1-3% bicarbonate of soda which adds the additional insulating properties by virtue of producing CO₂ which expands the composition requiring less thereof gradually into the funnel or the suitable hopper of the aspirator.

31. The method as defined in claim 29, wherein said step of feeding a gum, a fire retardant salt, and bicarbonate of soda which adds the additional insulating properties by virtue of producing CO₂ which expands the composition requiring less thereof gradually into the funnel or the suitable hopper of the aspirator includes feeding a gum, a fire retardant salt, and a dry powdered bicarbonate of soda which adds the additional insulating properties by virtue of producing CO₂ which expands the composition requiring less thereof gradually into the funnel or the suitable hopper of the aspirator.
